(19) United States
(12) Patent Application Publication
(10) Pub. No.: US 2004/0232837 A1
(43) Pub. Date: Nov. 25, 2004

(54) Incandescent lighting

(76) Inventor: Douglas Beverley Stevenson King, Lancashire (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/476,305

(22) PCT Filed: Jul. 9, 2003
(86) PCT No.: PCT/GB03/02964

(30) Foreign Application Priority Data
Jul. 20, 2002 (GB) 0216931.6

(51) Int. Cl. H01K 1/00; H01J 1/15; H01J 19/08

(52) U.S. Cl. 313/578; 313/315; 313/569; 313/341; 313/631

(57) ABSTRACT

An incandescent electric lamp having a tungsten filament embedded in tightly-packed layers of optically transparent, thermally insulating particles of substantially consistent size and shape and surrounded by an optically transparent, infra-red reflective coating, to provide a high efficiency, cool lighting system.

This invention relates to incandescent electric lamps.

Conventional incandescent lights are well known (“incandescence” refers to the light produced by the temperature of an object). A normal incandescent light bulb contains a short incandescent filament. This filament is usually a coil or multiple coils made up of about one metre of fine metal wire—because of its strength ductility and workability, tungsten can readily be formed into filament coils. Also, due to its high melting point temperature (about 3370° C.) tungsten can be heated to a high temperature (usually about 2500-3000° C.) where it glows white hot, providing a very bright light. In incandescent light bulbs, the tungsten is heated by passing an electric current through the filament, whereupon electrons collide with the tungsten atoms, causing the filament to get very hot.

Although tungsten has a relatively low evaporation rate at elevated temperatures (about 10⁻⁴ torr at 2757° C.), the tungsten tends to sublime quickly at the usual incandescent operating temperatures. Moreover, as tungsten sublimes from the filament the localised cross-sectional area of the tungsten wire reduces at certain points. Where this reduction in cross section occurs, there is a consequent rise in electrical resistance; this leads to an increase in heating effect and thus in the temperature at that location, which increases the rate of tungsten sublimation and accelerates the eventual failure of the filament. Also, as tungsten sublimes it coats the inside of the lamp bulb with a thin black film of tungsten, which reduces the overall light output.

In order to reduce tungsten sublimation/evaporation, inert gases such as nitrogen or argon may be added to the bulb. Whilst this reduces tungsten sublimation, the inert gas carries heat away from the filament, reducing its temperature and brightness. Also, the addition of inert gas only reduces tungsten evaporation, and so although it prolongs filament life it does so to a finite extent.

An improvement over inert gas-filled incandescent light bulbs can be achieved using halogens, such as iodine or bromine, together with inert gas. When the tungsten filament is heated in the presence of halogens, tungsten atoms still evaporate from the filament. These atoms quickly make their way to the interior surface of the bulb, where they cool on contact to about 800° C. At this temperature a chemical reaction takes place between the tungsten and the halogen to produce gaseous tungsten iodide or bromide. This tungsten halide migrates back to the filament, where the intense 3000° degree heat causes the relatively unstable halide to dissociate into elementary tungsten and free iodine/bromine. The tungsten is deposited on the tungsten filament, thus the filament is continuously regenerated, as is the halogen, in a cycle. Halogen bulbs therefore last considerably longer than inert gas light bulbs, they can also be operated at a higher temperature to produce a brighter light, towards the blue end of the spectrum (though this has the disadvantage that the outside of a halogen bulb is considerably hotter to the touch). In halogen lights, the bulb is normally made of quartz, glass being unable to withstand the high operating temperature.

A significant disadvantage of conventional incandescent lamps is their inefficiency: only about 10% of the energy radiated is in the visible spectrum, the majority of the remainder is emitted in the infra-red region—so about 90% of the output of a conventional incandescent lamp is unwanted heat, the dissipation of which can be problematic for lighting designers, particularly at the higher operating temperatures usual with halogen bulbs.

Accordingly, the present invention provides an incandescent electric lamp comprising an incandescent filament embedded in a porous matrix formed from a plurality of particles of a thermally insulating and optically transparent material, the particles being of substantially consistent size and/or shape.

With such an arrangement, when the tungsten filament is heated to incandescent temperature there is some evaporation of tungsten, but the tungsten atoms do not migrate far through the porous matrix; instead, they tend to be deposited onto the particles near to the filament where, because they remain in electrical contact with the filament, they are heated so as to emit radiation. These tungsten atoms also tend to evaporate and migrate back to the filament. Lamps in accordance with the invention have the advantages that there is no need for the surround to the matrix to be evacuated (although an inert gas atmosphere may confer advantages) and, more significantly, the lamp is more efficient and has a significantly lower external temperature than conventional tungsten filament incandescent lamps, due to the thermal insulation provided by the particles.

The particles may be made of any suitably thermally-insulative and optically transparent material capable of withstanding the tungsten filament operating temperature, such as carbon/zirconia/alumina/silica fibres or beads. A higher concentration of carbon is expected to be required closest to the tungsten filament in order to withstand the operating temperature—microcrystalline diamond would be suitable, for example.

Preferably the porous matrix has a substantially consistent porosity, comprising a plurality of similarly sized and/or shaped interstices between adjacent particles.

The regularity or consistency of the particles and the interstices is important for ensuring a required and reliable performance from the lamp. When the particle/interstice size is carefully chosen in conjunction with the visible emission wavelengths then these wavelengths will be preferentially emitted. Preferably, the mean particle and/or interstice sizes are a proper fraction or a multiple of the wavelength of a desired part of the optical spectrum, according to the light character derived from the lamp.

The porous matrix is suitably enclosed within a sealed optically transparent casing. Optionally, the porous matrix may be surrounded by a solid, thermally-insulative, optically transparent layer, to provide further thermal insulation, which is itself encased in sealed outer glass casing. A casing of some description is required to hold the particles in their matrix structure, it also provides an inner surface which can be coated with a discriminative reflective filter, such as a film of an optically transparent, infra-red reflective dielectric mirror so as to trap thermal radiation and reflect it back onto the filament, increasing its temperature and thus shifting its output spectrum toward the visible in accordance with black body radiation physics. Such discriminative reflective filters are described in, for example, U.S. Pat. No. 4,663,557 and EP 0361674.

Preferably the particles are beads of carbon, zirconia, alumina and/or silica. It is envisaged that these beads would be packed in a matrix of between at least 2 and about 10 layers deep surrounding the matrix. The overall thickness of the insulator is adapted to reduce heat loss from convection and conduction, thereby to increase filament temperature and visible light production.

Arrangements in accordance with the invention have several advantages over conventional halogen lamps. The lamps of this invention have a much greater visible light efficiency, with consequent energy savings, and they are safer because they have a low external temperature, and also because there need be no evacuated glass enclosure. When the lamps are turned off they will dim slowly, thus reducing thermo-mechancial shock. The lamps may operate on alternating or direct current, and they can be manufactured using existing production methods and with relatively cheap materials. Lamps in accordance with the invention have many applications beyond that of high efficiency general lighting. Because the lamps have a greatly reduced thermal output (compared to conventional halogen lights) they can be employed in any application where excess heat is undesirable, such as for illuminating microscope samples where the sample is susceptible to heat damage. The lamps are especially suitable for use in projectors and film scanners, where they can provide silent, fan-less and cool illumination; the lamps can also be used for low temperature television or film studio or theatre lighting.

The invention will now be described by way of example and with reference to the accompanying drawings, in which:

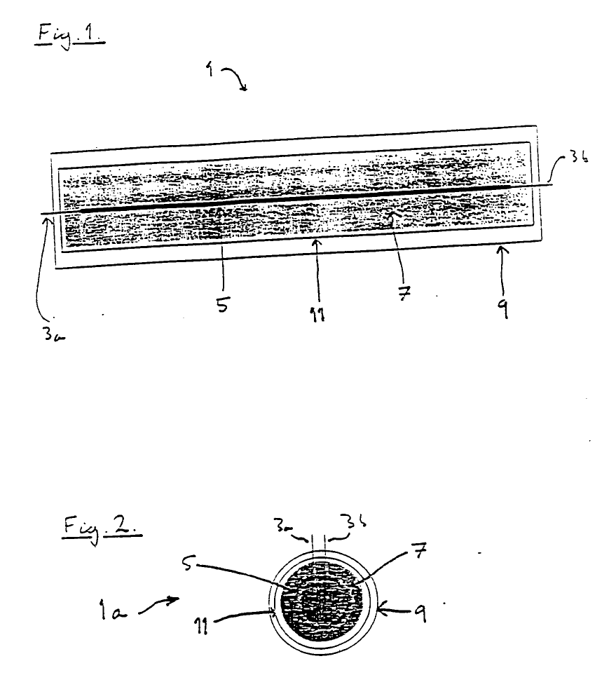

FIG. 1 is a schematic view of a cylindrical incandescent electric lamp in accordance with the invention, and

FIG. 2 is a schematic view of a spherical incandescent electric lamp in accordance with the invention.

In what follows, like elements are denoted in the Figures by the same reference numeral.

The embodiment illustrated in FIG. 1 is of clydindrical shape. This lamp 1 has electrical connectors 3a, 3b for passing electric current though tungsten filament 5, which is of conventional manufacture. Filament 5 is embedded in a porous matrix 7 of a thermally-insulative and optically transparent material. The matrix 7 is encased in an optically transparent casing 9, which has an inner coating 11 of an optically transparent, infra red reflective coating 11. As explained above, the porous matrix 7 is formed of particles (beads or fibres) of consistent size and shape, of carbon, zirconia, alumina or silica, the particles and the interstices there between being a fraction or a multiple of the desired wavelength, suitably that of green light or around 500 nm. The particles are in packed layers, between about 2 and about 10 layers deep.

In operation the tungsten partially evaporates and migrates to coat the insulating particles close to the filament 5 with a thin layer of tungsten. Because this thin layer is still in contact with the electrically conducting filament 5, this effectively increases the radiative area of the filament 5. The particle and interstice size is carefully chosen to preferentially emit visible wavelengths, and the filament coil geometry (i.e. coil diameter and spacing) is chosen so as to maximise the output emissions in conjunction with the particle dimensions. What infra-red emissions there are are attenuated by the matrix 7, and reflected back on the filament 5 by the coating 11.

The lamp 1a in FIG. 2 is in all significant elements identical to the lamp 1 of FIG. 1, apart from its shape, which is spherical rather than cylindrical. It will be appreciated that many straightforward modifications may be made to the illustrated embodiments and that such would not affect the scope of the appended claims. For example, the simple electrical connectors 3a, 3b may be in any conventional form as used in prior art lighting systems. The porous matrix 7 may comprise particles of two different consistent sizes, the smaller being adapted to fit snugly in the interstices between the larger particles when these are packed together. The porous matrix 7 may comprise an insulative layer formed around the filament as already described, but surrounded by solid, thermally insulating, optically transparent layer to improve thermal insulation, or the filament and the adjacent particles forming the porous matrix 7 may be retained by some other means (a film, for example) and surrounded by a further transparent matrix of thermally insulating particles, of different size, which in turn is enclosed by the outer casing 9.

1. An incandescent electric lamp comprising an incandescent filament embedded in a porous matrix formed from a plurality of particles of a thermally insulating and optically transparent material, the particles being of substantially consistent size and/or shape.

2. An incandescent electric lamp according to claim 1 wherein the porous matrix comprises a plurality of similarly sized interstices between adjacent particles.

3. An incandescent electric lamp according to claim 2 wherein the mean sizes of the particles and/or of the interstices are a proper fraction or a multiple of the wavelength of a desired part of the optical spectrum.

4. An incandescent electric lamp according to claim 1, wherein the porous matrix is enclosed in an optically transparent casing.

5. An incandescent electric lamp according to claim 4 wherein the casing has an optically transparent, infra-red reflective surface.

6. An incandescent electric lamp according to claim 1, wherein the particles are beads.

7. An incandescent electric lamp according to claim 1, wherein the matrix comprises particles of two consistent sizes, a plurality of particles of a first smaller size adapted to fit snugly in the interstices between tightly packed particles of a second, larger size.
